(19) United States
(12) Patent Application Publication
(10) Pub. No.: US 2001/0048538 A1
(43) Pub. Date: Dec. 6, 2001

(54) Multiple access system and method using a code-length division noise-spectrum protocol

(76) Inventor: Frank Victor Kowalski, Golden, CO (US)

Correspondence Address: Steven J Shattil, 4980 Meredith Way #201, Boulder, CO, 80303, US

(21) Appl. No.: 09/853,134

(22) Filed: May 9, 2001

Related U.S. Application Data
(60) Provisional application No. 60/207,182, filed on May 26, 2000.

(51) Int. Cl. H04J 14/08; H04B 10/00

(52) U.S. Cl. 359/136; 359/154

(57) ABSTRACT

Multiple transmitters generate repetitive waveforms having similar values of center frequency F and bandwidth B that are modulated with different information signals having bandwidth SB. Each transmitter generates a waveform having a unique repetition rate. The modulated waveforms are coupled into a communication channel. A receiver receives and separates the transmitted signals using a coherent correlation process, such as interferometry. The combining process extracts signals having a repetition period corresponding to a relative delay applied to consecutive waveforms. Waveforms having non-corresponding repetition periods combine non-coherently, thus enabling signal demultiplexing to be performed with respect to waveform repetition periods.

This is a Continuation of provisional appl. Ser. No. 60/207,182, filed on May 26, 2000.

### FIELD OF THE INVENTION

This invention relates to noise-spectrum communications systems and more particularly to optical and microwave noise-spectrum communications systems.

### BACKGROUND OF THE INVENTION

As the demand for data-communication services has grown, attempts have been made to increase optical-fiber system capacities. For example, in prior-art systems, wavelength division multiplexing (WDM) has been accomplished by modulating a plurality of lasers at different frequencies and transmitting the modulated light from the different lasers over the same fiber. Various forms of time-domain multiplexing have also been developed for communication over digital fiber networks.

There have been several proposals to use spread-spectrum protocols in digital optical networks. These are set forth in the following papers and presentations: “Coherent Ultrashort Light Pulse Code-Division Multiple Access Communication Systems”, Journal of Lightwave Technology, Vol. 8, No. 3, March 1990; L. Nguyen, B. Aazhang, J. F. Young “Optical CDMA with Spectral Encoding and Bipolar Codes”, Proc. 29th Annual Conf. Information Sciences and Systems (Johns Hopkins University, Mar. 22-24, 1995); N. B. Mandayan, B. Aazhang, “Optical Spectral Amplitude Code Division Multiple Access System” Proc. International Symposium on Information Theory, San Antonio Tex. p. 379 Jan. 17-22, 1993; M. Brandt-Pearce et al. “Performance Analysis of Single-user and Multiuser Detectors for Optical Code Division Multiple Access Communications,” IEEE Transactions on Communications, Vol. Com-43 No. 3 1995; A. Pasasakellariou et al. “Code Design for Interference Suppression in CDMA Systems with Continuous Phase Modulation” Proc. 29th Annual Conf. Information Sciences and Systems, Johns Hopkins U. Md. 1995; A Semiclassical Analysis of Optical Code Division Multiple Access, D. Brady and S. Verdu, IEEE Transactions on Communications, Vol. 39, No. 1, January 1991, pp. 85-93; W. C. Wong et al. “Synchronous vs. Asynchronous CDMA for Fiber Optic LANS Using Optical Signal Processing”, November 1989, pp. 1012-1016; and the following U.S. Pat. No. 5,519,526 to Chan et al.; U.S. Pat. No. 4,703,474 to Foschini et al.; U.S. Pat. No. 5,289,299 to Paek et al.; U.S. Pat. No. 5,499,236 to Giallorenzi et al.; U.S. Pat. No. 5,410,147 to Riza et al.; and U.S. Pat. No. 5,438,440 to Paek et al.

Optical Code Division Multiple Access (CDMA) permits efficient network control and switching, primarily because it overcomes the limitations of switching time associated with opto-electronic devices and the processing delay associated with network protocols. These switching-time and processing-delay limitations are particularly serious for ultra dense, Gigabit-per-second (Gb/s) networks. CDMA permits combined use of wavelength, frequency, time, and space, therefore increasing the information capacity of communication systems and devices. However, CDMA has limitations associated with the crosstalk of its codes. In CDMA, each uniquely coded channel contributes noise to the other channels. As the number of channels increases, this noise level increases dramatically. CDMA also has significant bandwidth-expansion requirements. The limitations of CDMA are serious enough to prevent it from being considered for any of the emerging ultra-dense Gb/s systems.

Several variations of CDMA and WDM have been proposed. In U.S. Pat. No. 5,867,290, a wideband light source is modulated with data. The modulated data is dispersed through a diffraction grating and then passed through a spatial spectrum-coding mask. The dispersed frequencies of the encoded modulated light beam are then recombined to provide a modulated, encoded spread-spectrum optical signal that is coupled into an optical fiber. An inverse mask or weighted detector array is used to decode received signals.

In U.S. Pat No. 6,025,944, data bits are multiplexed onto multiple wavelengths by a CDMA matrix time-delay encoder. Received signals are decoded by an inverse-CDMA matrix time-delay decoder. Desired signals are combined coherently whereas undesired signals combine non-coherently.

Data capacity in optical networks is limited by many factors related to the nonlinearity of the transmission medium and instability of the transmission sources. Solutions to these problems have been proposed. However, these prior-art solutions tend to be overly complex and relatively ineffective.

I. Dispersion

The principal limiting factor in high-rate communication systems is chromatic dispersion. Chromatic dispersion is characterized by a widening in the duration of pulses as they travel through a fiber. Dispersion is caused by the dependence of the effective index of the fiber on the wavelength of each wave transported. The variation in the index of refraction with respect to wavelength causes different channel wavelengths to travel at different speeds. This phenomenon is also known as group-velocity dispersion (GVD).

Increasing data-transmission rates severely limits the transmission distance because of the waveform distortion caused by GVD in optical fibers. Furthermore, when the transmission speed is increased, the optical power for transmission needs to be increased to maintain the required received optical-power levels.

Many techniques and devices have been devised to counter the effects of GVD. The goal of dispersion compensation is to change a nonlinear channel into a linear channel (at least for a specific range of wavelengths) in order to achieve the capacity of a linear channel. None of these references disclose a multiple-access protocol that is substantially insensitive to dispersion.

U.S. Pat. No. 4,677,618 describes a method of compensating for distortion of WDM data by a dispersive medium. Dispersion-compensation techniques include providing lengths of dispersion-compensating line in an optical network (U.S. Pat. No. 5,361,234) and providing dispersion-slope compensation, such as disclosed by J. A. R. Williams et al. in IEEE Photonics Technology Letters, Vol. 8. p. 1187 (1996) and K. Takiguchi et al. in Electronics Letters, Vol. 32 p. 755 (1996). However, these dispersion-compensation methods have relatively limited effectiveness with respect to bandwidth.

To minimize the dispersion value of optical signals in fiber, work is currently under way to transmit signals in the 1.55-μ range in a dispersion-shifted fiber. U.S. Pat. Nos. 5,943,151, 5,898,714, 5,877,879, and 5,828,478, describe methods of phase comparisons and synchronization to compensate for chromatic dispersion.

II. Other Distortions

Other types of distortion also occur. U.S. Pat. No. 5,847,862 describes shaping of amplifier outputs to offset depletion of high-frequency channels. A significant factor in signal-to-noise ratio (SNR) degradation in WDM is due to Raman crosstalk. U.S. Pat. No. 5,953,140 cancels out the effects of crosstalk by processing signals in the electrical domain after the WDM transmission has been demultiplexed. Also, smoothing the power variation of the optical signal transmitted through the fiber can reduce nonlinear effects. U.S. Pat. No. 5,589,969 addresses the problem of interference caused by four-wave mixing between different WDM signals by providing a non-periodic spacing between the signal wavelengths.

III. Wavelength Drift

WDM lasers require extremely tight manufacturing tolerances with respect to center wavelength and line width. There are significant problems with laser-wavelength drift resulting from environmental factors, such as temperature variations and aging. Wavelength drift causes substantial problems in distributed systems because each receiver needs to demultiplex signals from different transmitters and from different fiber lines, all of which independently operate under different and changing environmental conditions. Conventional WDM systems require strict manufacturing and environmental controls to stay within tolerance.

Efforts to improve WDM systems have focused on improving the wavelength stability of the transmitter lasers. U.S. Pat. No. 5,943,152 describes a method for stabilizing the wavelength of an optical source. U.S. Pat. No. 5,838,470 addresses the problem that WDM transmitters and receivers must be precisely tuned to predetermined fixed wavelengths. In the '470 patent, each transmitter transmits a synchronization signal that the receiver uses to determine the wavelength of the signals. These signal wavelengths are stored in a lookup table.

U.S. Pat. No. 5,894,362 includes a decoupling unit for decoupling a portion of the WDM signal from a fiber as a monitoring signal. A monitoring unit determines the spectrum of the WDM signal with an optical spectrum analyzer. The monitoring unit uses the spectrum information to control light sources such that the wavelength is constant for each signal. The monitoring unit also detects SNR and signal power, maintains received power levels, counts the number of channels in a WDM signal, measures the spacing between wavelengths, monitors any changes in the spectrum, and controls optical amplifiers to achieve a desired noise figure or maintain a flat gain.

U.S. Pat. No. 5,555,086 describes a sensor array used to monitor physical characteristics of an optical fiber. A two-mode signal is sent through the fiber. Each mode has a different propagation velocity to create an interference pattern at a sensor array. Changes in the interference pattern indicate changes in the physical characteristics of the fiber.

None of the references disclose a communication protocol that is substantially insensitive to the effects of carrier-frequency drifts and distortion.

IV. Coherence Multiplexing

Coherence multiplexing is an optical interferometric technique that divides a noise waveform into two parts. One part has a predetermined delay or path-length difference (code waveform) while the other part has an information signal impressed upon it (code plus signal waveform). Both of these signals are then combined to propagate simultaneously on the communication channel. At the receiver, the predetermined delay is used to correlate the signals. Thus, coherence multiplexing enables several signals transmitted synchronously over an optical fiber to share a common optical bandwidth.

In U.S. Pat. No. 4,866,698, Huggins et. al. describes a coherence multiplexed optical communication system in which a plurality of modulators have path lengths that differ by an amount greater than the coherence length of a wideband transmission source. Similarly, each detector of a receiver system has a path length difference associated with a particular modulator by an amount no greater than the coherence length of the source.

If the source generates noise via random phase modulation then interferometric noise limits the information transfer rate. Interferometric noise is a problem for distributed feedback lasers, as shown in “Solution Paths to limit Interferometric Noise Induced Performance Degradation in ASK/Direct Detection Lightwave Networks,” P. J. Legg, M. Tur and I Andonovic, Journal of Lightwave Technology Vol 13, No 7 July 1995. When simultaneously propagating both the code and the code plus signal on the same channel, as described in U.S. Pat. No. 4,866,698, this noise is enhanced.

In the Applied Optics paper, “Noise in Coherence-Multiplexed Optical Fiber Systems,” differential detection is shown to reduce noise resulting from uncorrelated signals in an optical sensor system.

U.S. Pat. No. 5,691,832 describes a modulation technique that reduces autocorrelation peaks for non-zero delays. These secondary peaks result from periodic terms in the correlated signals. A decorrelation modulator is used to attenuate periodic components in the autocorrelation function. The decorrelation modulator also adjusts the coherence of a carrier signal to narrow the autocorrelation peak of the signal for zero delay.

U.S. Pat. No. 5,610,746 describes an optical system that uses a programmable switched delay encoder to select a sequence of carrier frequencies that provide encoding of an information signal. Carrier frequencies are generated via Fabry-Perot resonation (which is a type of frequency filtering) with respect to delays that the encoder provides to a wideband signal before it is fed back into a gain medium. The encoded signal is decoded at a receiver that uses an arrangement of feedback waveguides that is similar to the feedback system used in the decoder.

### SUMMARY OF THE INVENTION

It is a first object of the invention to provide a noise-spectrum communication protocol that is substantially insensitive to the effects of carrier-frequency drifts and distortion. It is a second object of the invention to provide a relatively simple system for encoding and decoding electromagnetic waves (such as light and radio signals) while efficiently using the entire available spectrum. It is yet a third object of the invention to provide a noise-spectrum communication system having codes that may be readily reassigned to other transmitters in the network.

These objects are accomplished using a source of electromagnetic waves that generates a repetitive waveform in the absence of an information signal. Different sources, each having emissions with similar values of center frequency F and bandwidth B, are modulated with different information signals. The modulation bandwidths of the signals are referred to as SB. The output from each source is coupled into a communication channel (such as a waveguide or free-space channel). Waveforms received from the channel are separated using a process, such as interferometry.

Each source generates a repetitive waveform of duration L/c, where c is the speed of light and L is a length associated with a particular source. The waveform may have a broad spectrum, such as a noise spectrum with bandwidth B. At a receiver, a waveform from a particular source interferes constructively with itself only after a temporal delay that is related to an integer multiple of the repetition duration L/c. This property is used by the receiver to extract information from the source. For example, the receiver may be a Michelson interferometer that has a path-length difference set to L. When a repetitive waveform with duration L/c is coupled into the interferometer, constructive interference occurs between consecutive waveforms. This interference occurs over a distance related to the coherence length associated with the bandwidth B.

Consequently, another object of the invention is to provide a noise-spectrum protocol wherein the repetition period of each transmission is part of a key used to encode and decode information signals. This protocol is unique in that the code and code plus signal are not transferred simultaneously.

As only one interferometer is required to decode each signal, it is another object of the invention to provide a single receiver that can decode the multiple received signals.

The applications of this fundamental concept are broad. For example, this protocol may be used in any region of the electromagnetic spectrum, and it may be used for coding transmissions in either or both waveguide and wireless channels. This protocol may be used in any type of system that employs electromagnetic transmission and/or reception including, but not limited to, communications, imaging, and remote sensing.

The objectives of the present invention recited above, as well as additional objects, are apparent in the description of the preferred embodiments and the claims.

### BRIEF DESCRIPTION OF THE DRAWINGS

FIG. 1 is a process diagram of a communication method that uses noise-spectrum protocol of the present invention.

FIG. 2 is a diagram of a communication system that transmits and noise-spectrum signals having a bandwidth B and a center frequency F.

FIG. 3 is a diagram of a frequency-shifted feedback laser.

FIG. 4 shows a code-length multiple access system in which multiple noise-spectrum signals having similar bandwidth B and center frequency F are transmitted, received, and then separated.

FIG. 5 shows a detector that separates code-length division multiple access signals.

FIG. 6 is a diagram of a free-space communication system that includes a multi-element receiver that functions as an interferometer.

### DETAILED DESCRIPTION OF PREFERRED EMBODIMENTS

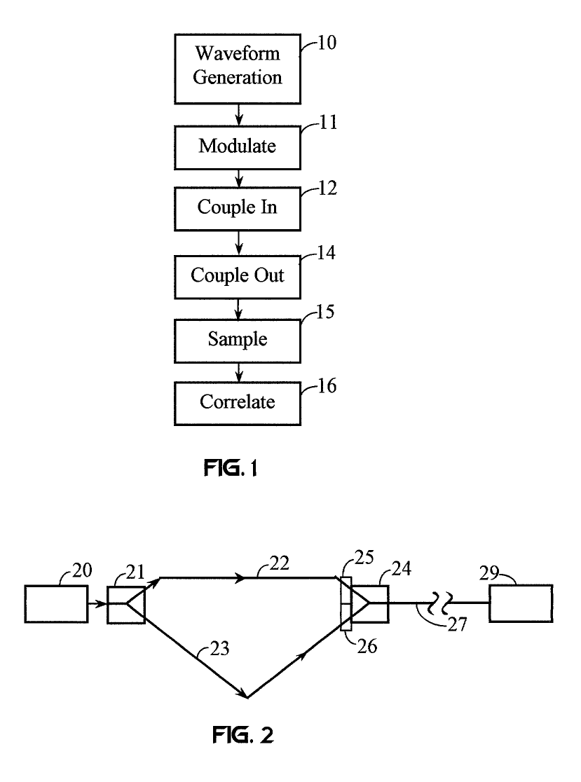

FIG. 1 shows a communication method that uses the noise-spectrum protocol of the present invention. At least one repetitive waveform having at least one predetermined period is produced in a waveform-generation step 10. A modulation step 11 modulates an information signal onto at least a portion of at least one cycle of the repetitive waveform. Modulation includes any signal-processing technique in which information signals are modulated or otherwise impressed onto a carrier waveform. One or more modulated repetitive waveforms are coupled into a communication channel (not shown) in a first coupling step 12.

A sequence of reception steps is performed to recover at least one desired signal from the channel (not shown). A receiver (not shown) couples transmitted waveforms out of the channel (not shown) in a second coupling step 14 to provide at least one received signal. A sampling step 15 provides delay sampling of the received signal. For example, the received signal may be split (or otherwise duplicated) to provide multiple identical signal components that are provided with different delays. A combining step 16 is performed to provide a coherence analysis of the delayed components. The sampling step 15 and the combining step 16 may be combined in an interferometry step (not shown) that enables detection of signal components that combine coherently. A decision step (not shown) may be used to process information signals recovered from coherently combining the signal components.

A novel feature of the noise-spectrum protocol of the present invention is that the means to decode a transmitted noise-spectrum signal is not transmitted simultaneously over the same communication channel with the encoded signal. This reduces interferometric noise. The encoded signal is decoded by combining a received code segment in at least one period of the repetitive waveform with a received encoded information signal from at least one other period of the waveform. This method allows simpler receiver designs because the receiver is not required to generate a despreading code. Furthermore, the protocol enables truly random (rather than pseudo-random) noise to be used as spreading codes because the spreading codes do not need to be recreated by the receiver.

It is preferable that the spreading codes have high ratios of self-coherence to cross-coherence. Repetitive noise (or noise-like) signals exhibit desirable self-coherence to cross-coherence ratios. Noise signals with different periods combine non-coherently whereas replicas of a given noise signal having perfectly matched delays combine coherently. Thus relative delays applied to components of received repetitive signals at a coherence receiver determine which transmission signals are detectable by the receiver relative to the transmission signal period. The relationship between signal periods and receiver delays allows both transmitters and receivers to easily adapt to different noise-spectrum channels that are defined by code length. Therefore, communication channels defined by noise-spectrum code lengths provide an efficient means of multiple access.

FIG. 2 illustrates one method for generating repetitive waveforms. An electromagnetic source 20 produces radiation having a bandwidth B and a center frequency F. The source 20 may be an incoherent source, such as a light-emitting diode. The source 20 may be a single-frequency source that is phase, frequency, and/or amplitude modulated randomly (or pseudo-randomly). The output from the source 20 is split into two beams by a beamsplitter 21. Each of the split beams traverses one of a plurality of paths 22 and 23. In this case, path 22 has a path length L and path 23 has a path length equal to 2L. The split beams are coupled into a communication channel 27 (such as a waveguide) by a beamsplitter 24. A plurality of shutters 25 and 26 allow for only one of the beams to enter and exit the beamsplitter 24 at a given time. For example, shutter 25 is opened for a duration L/c while shutter 26 is closed, thus allowing only the beam along path 22 to propagate through the channel 27. Immediately thereafter, shutter 25 is closed and shutter 26 is opened for a duration L/c to allow the beam received from path 23 to propagate through the channel 27. Because the length of path 23 is 2L and the length of path 22 is L, this process generates sequential pairs of identical waveforms that each have a duration L/c.

The path length L can be made large in the optical spectrum by using fiber waveguides. A surface acoustic-wave device embodies one possible way to increase L in the radio-frequency spectrum. There are two advantages to using a large value of L. First, given a fixed bandwidth B, a larger number of signals can be transmitted and then separated. Second, any periodic noise (e.g., noise resulting from switching from path 22 to path 23 in FIG. 2) associated with a waveform having a large L will be at frequencies that are small compared with frequencies of the signal.

The wave along either path 22 or path 23 may be frequency shifted an amount Δf by a device not shown. One advantage of such a shift is to provide a heterodyne signal at the receiver. Another advantage is to provide a means for frequency-division multiplexing, which is discussed below.

Beams in the channel 27 are coupled into a coherence receiver, such as an interferometer 29 having a path difference D. If D is not equal to L, the beams combine incoherently. If D is equal to L, the interferometer 29 provides a delay that allows the beams to combine coherently. The coherent addition occurs for variations in the interferometer path difference associated with the bandwidth B of the source (i.e. the coherence length).

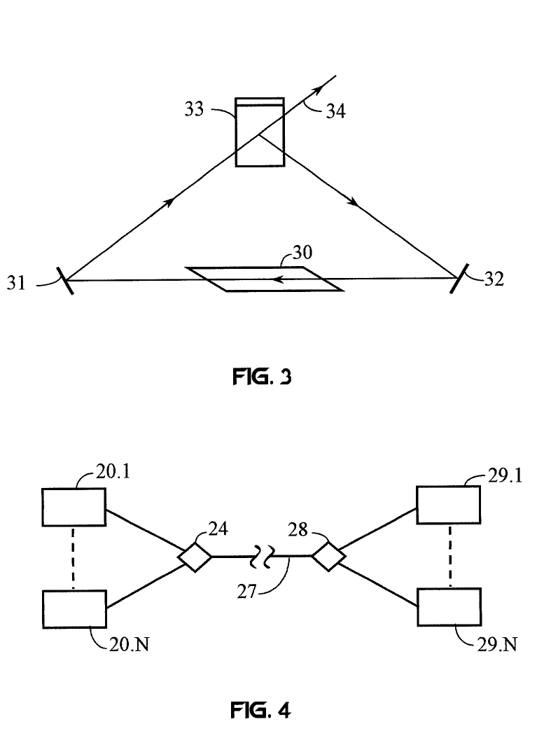

FIG. 3 shows a frequency-shifted feedback laser that may be used as a source of the repetitive noise waveform. Spontaneously emitted light from a gain medium 30 is circulated through an acousto-optic modulator (AOM) 33 by a plurality of mirrors 31 and 32. The AOM 33 provides a frequency-shift Δf to light propagating through the laser cavity and diffracts light that is fed back into the gain medium 30. Light is output from the laser via an undiffracted beam 34 from the AOM 33. The laser has a round-trip length of L.

Characteristics of the output depend on various parameters, such as the relation of c/L to the AOM 33 modulation frequency. However, it is possible for a substantial portion of the output to consist of a repetitive waveform having a period L/c. A particular segment of duration L/c consists of a broad spectrum having bandwidth B and center frequency F. The sequential segments are identical, except for a frequency shift resulting from the AOM 33. The frequency-shifted feedback laser may be similar to a laser described by F. V. Kowalski, P. D. Hale, and S. J. Shattil in “Broadband continuous-wave laser,” Optics Letters, Vol. 13, 622, which is hereby incorporated by reference.

An information signal of bandwidth SB can be modulated onto a repetitive source output by any modulation technique, such as phase or frequency modulation. Modulation may be performed within a source or on a beam output from a source. Different signals are imposed on beams output by different sources.

A preferred modulation scheme involves phase modulating only one segment (i.e., period) of a repetitive source output, leaving a sequential segment unmodulated. When the two segments are combined at an interferometer, the phase modulation causes an intensity variation of the beam at the output port of the interferometer. The information signal is then decoded from the intensity variation.

If at least one of the consecutive waveforms is shifted by a frequency shift Δf, the information signal is imposed on a carrier frequency that has a value Δf away from the base frequency of adjacent waveforms. Thus, the interferometer combines waves having different frequencies. This procedure avoids the large noise spectral density at the base frequency and enables frequency division multiplexing.

A first waveform generator, which is similar to the system shown in FIG. 2, has path lengths 22 and 23 of L and 2L. A frequency shift of Δf is introduced along path 22. A second waveform generator, which is similar to the system shown in FIG. 2, has path lengths 22 and 23 of L and 2L. A frequency shift of twice Δf is introduced along path 22. If the information bandwidth SB is less than Δf. An interferometer at the receiver 29 has a path difference L, which detects signals imposed upon both the first and second waveform generators. However, the received signals are displaced in frequency by Δf and 2Δf, allowing the signals to be separated in the frequency domain.

FIG. 4 shows a code-length multiple access system in which noise-spectrum signals having similar bandwidth B and center frequency F are transmitted, received, and then separated. A plurality N of transmitters 20.1 to 20.N transmit periodic packets of electromagnetic energy having similar bandwidths B and center frequency F upon which different information signals are modulated. Each transmitter 20.1 to 20.N generates repetitive packets having a unique period T(j), where j=1, . . . , N. Consecutive packets may have an overall frequency shift relative to each other. The length of each packet is L(j)=cT(j), where c is the speed of light and L(j) is the length of the j^{th} packet.

The signals output from the N transmitters 20.1 to 20.N are coupled into a communication channel 27. Signals from the transmitters 20.1 to 20.N maybe coupled into a waveguide 27 through a coupler 24, such as a star coupler. Similarly, an antenna (not shown) or any other type of radiator may be used to couple transmitted signals into a free-space channel 27. A coupler 28 couples the transmitted signals from the channel 27 into a plurality N of receivers 29.1 to 29.N. The receivers 29.1 to 29.N may include any type of interferometer, such as, but not limited to Michelson interferometers and Mach-Zehnder interferometers.

One advantage of a Mach-Zehnder interferometer is that the intensity at the output ports due to a phase modulation of the injected beam oscillates out of phase while the intensity noise on the two beams is identical. Therefore, in an ideal system, subtracting the two intensity signals can eliminate noise. Inserting a frequency shifter (not shown) into one arm of an interferometer compensates for any frequency offset in consecutive packets and can also allow for homodyne or heterodyne detection.

Each of the interferometers 29.1 to 29.N combines consecutive packets received from the channel 27. The j^{th} interferometer has a path difference L(j) corresponding to the period T(j) of the packets generated by a j^{th} transmitter. The path difference L(j) corresponds to the distance at which constructive interference occurs for that packet.

The distance over which the fringe visibility is non-zero in this interferometer is determined by the bandwidth B of the source. The path differences L(j) are preferably much larger than the coherence length of the transmission source. Also, the distances L(j)-L(j−1), for all j, are chosen to be larger than the coherence length. Therefore, the j^{th} interferometer will exhibit a non-zero interference pattern (have a non-zero visibility function) for only the j^{th} source. The beam from the (j′)^{th} source, for example, will have a zero visibility function at the j^{th} interferometer for all j≠j′. Thus, the information imposed on each beam can be separated by the interferometers.

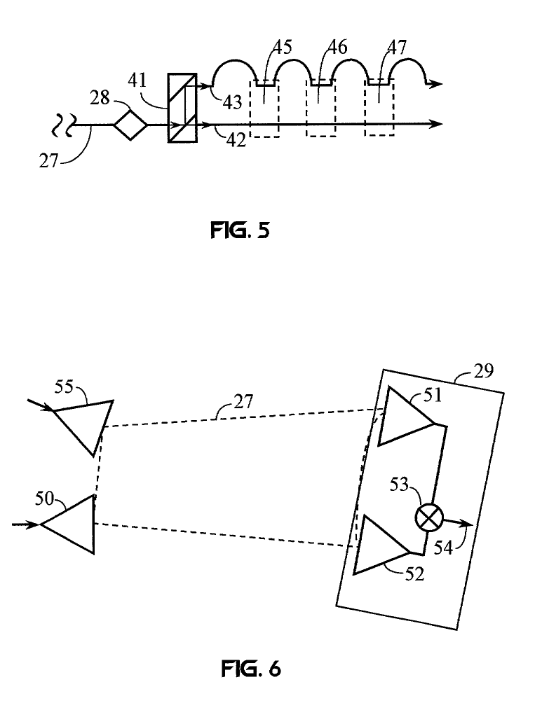

FIG. 5 shows a detector that separates code-length multiple access signals. Signals received from a communication channel 27 are coupled into the detector and split by a beamsplitter 41 and coupled into a plurality of waveguides 42 and 43. The waveguides 42 and 43 are close to each other at a plurality of positions, such as near-point positions 45, 46, and 47. The distances traveled along each of the waveguides 42 and 43 from the beamsplitter 41 to the near points 45, 46, and 47 are not equal. The path-length difference between each waveguide 42 and 43 from the beamsplitter 41 to each near point 45, 46, and 47 corresponds to a length L(j) for a particular transmission source. For example, the path difference at the near point 46 may correspond to the packet length L(j) of source j=3. Thus, the evanescent waves from the two waveguides overlap and coherently add in the vicinity of the near point 46 only for source j=3.

Signals at the near points 45, 46, and 47 may be extracted in a variety of ways. One or more detectors (not shown) may be inserted between the waveguides 42 and 43. One or more additional waveguides (not shown) may be positioned close to a near point 45, 46, or 47 to receive energy coupled by evanescent waves. The additional waveguide or waveguides (not shown) may include a non-linear material (which has an index of refraction that varies as a function of the strength of an applied electric field). At a particular near point (such as near point 46), the electric field from a particular transmission source affects the refractive index of the non-linear material, thereby coupling more energy into the additional waveguide or waveguides (not shown) located at the near point 46. The additional waveguide or waveguides (not shown) may include a gain medium for amplifying evanescent waves coupled into it. Other waves may be injected into the third waveguide to extract evanescent waves by non-linear processes, such as four wave mixing.

A free-space communication system is shown in FIG. 6. A plurality of transmit sources, such as sources 50 and 55 couple periodic transmit signals into a free space communications channel 27. The transmit signals have at least one path-length period ΔL. A receiver 29 includes two spatially separated antennas 51 and 52 connected to a combiner 53 that combines signals generated by the responsiveness of the antennas 51 and 52 to received radiation. The combined signals are output at a combiner output 54. A path difference ΔL between the source 50 and combiner 53 via the antennas 51 and 52 cause the source 50 and the receiver 29 to perform like an interferometer. The difference in path length ΔL is determined by the difference in the propagation distance between the source 50 to antenna 51 to the combiner 53 and the source 50 to antenna 52 to the combiner 53. If the path difference ΔL of the interferometer corresponds to the packet length of the j=3 source, the interferometer is capable of receiving a signal transmitted by this source.

If the source 50 moves to a different location (such as where source 55 is located), the interferometer's path difference ΔL changes. In this case, the path difference ΔL is no longer L(j=3). If ΔL differs from the length L(j=3) by an amount greater than the coherence length of the source j=3, then the coherence will be small and relatively unmeasurable.

The receiver illustrated in FIG. 6 measures signals only from a source with a particular ΔL corresponding to L(j=3). Other antenna pairs having path differences ΔLⱼ commensurate with code lengths L(j) of other sources detect signals from only those sources. Because the angular orientation of the antenna with respect to signal sources determines the effective path difference ΔL of the system, angular orientation with respect to code length may be used to provide directivity to multi-element receivers, such as the receiver illustrated in FIG. 6. Thus, the receiver could be used for directive multiplexing as each interferometer may be sensitive to signals received from a certain direction.

The multi-element receiver shown in FIG. 6 also provides an additional dimension of diversity. By combining the outputs of two receivers, each being spatially separated or oriented in a different direction, diversity is achieved. One advantage of such a set up is that it is insensitive to multipathing or reflections of the signal from nearby structures. Another advantage is that it could used as a directional device to locate a source.

Although the examples described herein predominately reference an optical-fiber waveguide, the code-length division protocol can be implemented in other frequencies, communication channels and wave phenomena. It will be appreciated that any broadband source may be used to provide repetitive signals. The broadband source can be a true noise source, such as spontaneous emission or other random emission processes. Detailed knowledge of the characteristics of the spectrum or the coding is not needed at either the source or the receiver to implement CLDMA.

Although interferometers described in the preferred embodiments are designed to interfere consecutive packets, the interferometry technique is also applicable for combining non-consecutive packets.

Although CLDM is similar to spread spectrum technology in that the signal is impressed upon a noise code, important differences exist. First, the code and code plus signal are both transmitted. Second, the code is a random rather than pseudo-random waveform. Third, knowledge of the code is not necessary. Fourth, there is no chip duration. Fifth, the code bandwidth does not have to be greater than the signal bandwidth. Sixth, the technique can easily be implemented in the optical regime.

The foregoing discussion and the claims that follow describe the preferred embodiments of the present invention. With respect to the claims, it should be understood that changes could be made without departing from the essence of the invention. To the extent such changes embody the essence of the present invention, each naturally falls within the breadth of protection encompassed by this patent. This is particularly true for the present invention because its basic concepts and understandings are fundamental in nature and can be broadly applied.

I claim:

1. A reception method for detecting at least one information signal modulated on at least one repetitive waveform, the method comprising:
coupling the repetitive waveform out of a communication channel, the repetitive waveform having at least one predetermined period, and
combining at least a first time-domain sample of at least one of the repetitive waveforms with at least a second time-domain sample of at least one of the repetitive waveforms to generate at least one coherence signal indicative of the at least one information signal.

2. The reception method of claim 1 wherein the communication channel is at least one of a waveguide and a free-space propagation medium.

3. The reception method of claim 1 wherein the at least one repetitive waveform includes a plurality of repetitive waveforms, each of the plurality of repetitive waveforms having similar values of center frequency and bandwidth.

4. The reception method of claim 1 wherein each of a plurality of the repetitive waveforms has a different period.

5. The reception method of claim 1 wherein the repetitive waveforms have a bandwidth comprised of at least one of a set comprising a continuous spectrum, a comb of spectral lines, a single spectral line that is randomly modulated, and a single spectral line that is pseudo-randomly modulated.

6. The reception method of claim 1 wherein the repetitive waveforms are noise waveforms.

7. The reception method of claim 1 wherein each repetitive waveform is modulated by a plurality of information signals.

8. The reception method of claim 1 wherein the at least one repetitive waveform is phase modulated by the at least one information signal.

9. The reception method of claim 1 wherein the combining step includes at least one interferometry step wherein at least one of the time domain samples is delayed and combined with at least one other time-domain sample.

10. The reception method of claim 9 wherein the delay corresponds to the waveform period.

11. The reception method of claim 9 wherein the time-domain samples that are combined are consecutive samples of the repetitive waveform.

12. The reception method of claim 9 wherein the time-domain samples that are combined are non-consecutive samples of the repetitive waveform.

13. The reception method of claim 9 wherein the at least one interferometry step is performed by at least one of a Michelson interferometer and a Mach-Zender interferometer.

14. The reception method of claim 1 wherein the combining step includes frequency shifting at least one of the time-domain samples.

15. A reception method for separating information signals modulated onto a plurality of repetitive waveforms having different periods, the method comprising:
coupling the waveforms out of a communication channel,
generating a plurality of time-domain samples of the received waveforms having at least one time offset relative to at least one of the signal periods, and
correlating the plurality of time-domain samples.

16. The reception method of claim 15 wherein the steps of generating a plurality of time-domain samples and correlation of the samples is performed by an interferometer.

17. The reception method of claim 15 wherein the step of coupling the waveforms out of a communication channel is performed by an array of receiving elements.

18. The reception method of claim 15 further comprising a step of frequency shifting at least one of the time-domain samples prior to combining the samples.

19. The reception method of claim 15 wherein the time-domain samples that are combined are consecutive samples of the repetitive waveform.

20. The reception method of claim 15 wherein the time-domain samples that are combined are non-consecutive samples of the repetitive waveform.

21. In an electromagnetic-wave communication system, a transmission method for transmitting at least one information signal modulated on at least one repetitive waveform, the method comprising:
generating at least one repetitive waveform having at least one predetermined period,
modulating at least one information signal onto at least one of the waveforms, and
coupling the waveforms into a communication channel.

22. The transmission method of claim 21 wherein the modulating step includes one or more of a set comprising phase modulation and frequency modulation.

23. The transmission method of claim 21 wherein the generating step is characterized by generating a repetitive noise waveform.

24. The transmission method of claim 21 wherein the generating step is characterized by generating a repetitive noise waveform having at least one component being frequency-offset from at least one other component.

25. The transmission method of claim 21 wherein the generating step includes generating a plurality of repetitive waveforms having similar values of center frequency and bandwidth.

26. The transmission method of claim 21 wherein each of a plurality of the repetitive waveforms has a different period.

27. The transmission method of claim 21 wherein the generating step includes generating repetitive waveforms that have a bandwidth comprised of at least one of a set comprising a continuous spectrum, a comb of spectral lines, a single spectral line that is randomly modulated, and a single spectral line that is pseudo-randomly modulated.

28. A transmitter for transmitting at least one code-length division multiple access signal, the transmitter comprising:
a waveform generator capable of generating a repetitive waveform having at least one predetermined period,
a modulator capable of modulating at least one information signal onto at least one portion of at least one period of the repetitive waveform, and
a coupler capable of coupling the modulated information signal into a communication channel.

29. The transmitter of claim 28 wherein the modulator phase modulates the information signal onto at least one portion of at least one period of the repetitive waveform.

30. The transmitter of claim 28 wherein the waveform generator generates a repetitive noise waveform.

31. The transmitter of claim 28 wherein the waveform generator generates a plurality of repetitive waveforms having similar values of center frequency and bandwidth.

32. The transmitter of claim 28 wherein the waveform generator generates a plurality of repetitive waveforms having different periods.

33. The transmitter of claim 28 wherein the waveform generator generates a plurality of repetitive waveforms having at least one frequency offset.

34. The transmitter of claim 28 wherein the waveform generator generates repetitive waveforms that have a bandwidth comprised of at least one of a set comprising a continuous spectrum, a comb of spectral lines, a single spectral line that is randomly modulated, and a single spectral line that is pseudo-randomly modulated.

35. A receiver for receiving at least one code-length division multiple access signal, the receiver comprising:
an input coupler coupled to a communication channel capable of receiving a plurality of repetitive waveforms having at least one predetermined period, and
a combiner coupled to the input coupler, the combiner capable of providing a plurality of time-domain samples of the received waveforms, at least one of the samples being time offset relative to the at least one predetermined period, the combiner capable of combining the time-domain samples for generating a coherence signal indicative of at least one information signal modulated onto at least one of the noise signals.

36. The receiver recited in claim 35 wherein the input coupler includes an array of receiving elements.

37. The receiver of claim 35 wherein the combiner combines consecutive time-domain samples of the repetitive waveform.

38. The receiver of claim 35 wherein the combiner combines non-consecutive time-domain samples of the repetitive waveform.

39. The receiver recited in claim 35 wherein the combiner includes an interferometer.

40. The receiver of claim 39 wherein the interferometer is at least one of a set comprising a Michelson interferometer and a Mach-Zender interferometer.

41. The receiver of claim 35 further comprising a frequency shifter for frequency shifting at least one of the time-domain samples.
